(19) United States
(12) Patent Application Publication
(10) Pub. No.: US 2002/0092361 A1
(43) Pub. Date: Jul. 18, 2002

(54) Transverse force sensor insensitive to bending and torsional moments

(76) Inventors: Zlatko Penzar, Frankfurt (DE); Jurgen Irion, Wittingen (DE); Wolfgang Porth, Frankfurt (DE); Andrea Rassler, Steinbach (DE)

Correspondence Address: Richard A. Speer, MAYER, BROWN & PLATT, P.O. Box 2828, Chicago, IL, 60690-2828, US

(21) Appl. No.: 09/954,745

(22) Filed: Sep. 18, 2001

(30) Foreign Application Priority Data
Sep. 19, 2000 (EP) DE 200 16 328.0
Jul. 17, 2001 (EP) DE 101 35 638.2

(51) Int. Cl. G01N 3/20

(52) U.S. Cl. 73/849

(57) ABSTRACT

The invention relates to a transverse force sensor with a bridge circuit having strain-sensitive resistors, the strain-sensitive resistors being arranged immediately on a component on which bending forces act directly without intermediate support, as a result of which an electric signal corresponding to the strain of the thick-film resistors can be tapped at the bridge circuit.

In a transverse force sensor in which the generation of an error-free bridge signal is ensured given a varying load, the strain-sensitive resistors (R1, R2, R3, R4) of a first bridge circuit are arranged on the component (1) like a circle, one resistor (R1, R3) each of the first bridge arm being arranged diagonally relative to a resistor (R4, R2) of the second bridge arm, respectively in a position (r) such that the bridge signal depends only on the transverse force.

The invention relates to a transverse force sensor with a bridge circuit having strain-sensitive resistors, the strain-sensitive resistors being arranged immediately on a component on which bending forces act directly without intermediate support, as a result of which an electric signal corresponding to the strain of the thick-film resistors can be tapped at the bridge circuit.

Transverse force sensors known per se have bridge circuits which are formed with the aid of strain-sensitive thick-film resistors which are arranged immediately on a component to be loaded with transverse forces. The resistors of the bridge circuits are arranged outside the direction of extent of a phase of the component that is neutral for bending load, and are at a prescribed distance and a prescribed angle from said phase.

Upon the application of spatially varying bending moments, however, different changes in resistance and, additionally, torsional influences occur in the case of the resistors and falsify the measurement result.

It is therefore the object of the invention to specify a transverse force sensor in which the generation of an error-free bridge signal is ensured in the case of a varying load.

The object is achieved according to the invention by virtue of the fact that the strain-sensitive resistors are arranged on the component approximately like a circle, one resistor each of the first bridge arm being arranged diagonally relative to a resistor of the second bridge arm, respectively in a position in which the changes in resistance of the strain-sensitive resistors assume different values under the influence of a transverse force, such that the bridge signal depends only on the transverse force.

The invention has the advantage that the signal changes caused by disturbances, in particular, bending influences, need not be compensated in circuitry, but is achieved solely by the placement of the resistors.

Owing to the arrangement according to the invention, the resistors of each arm of the bridge circuit are arranged on both sides relative to a phase neutral to bending loading in such a way that the strain-sensitive resistors, situated on one side of the neutral phase, of each bridge arm undergo identical changes in resistance given a change in bending load, the output signal that can be tapped at the bridge circuit having no components as a consequence of the bending load.

In the case of a bending load, the strain-sensitive resistors are advantageously arranged about the flexurally stiff axis such that the changes in resistance of the resistors of a bridge arm proceed oppositely with the same absolute value. Alternatively, in the case of a bending load about the flexurally soft axis, the strain-sensitive resistors of a bridge arm are arranged in such a way that an identical change in resistance occurs. Provided for the purpose of compensating the torsional influences is a second bridge circuit whose strain-sensitive resistors are likewise arranged like a circle, one resistor each of the first bridge arm being arranged diagonally relative to a resistor of the second bridge arm, respectively in a position in which, under the action of torsion, the changes in resistance of the strain-sensitive resistors of the second bridge circuit assume equal absolute values, and the output signals of the first and the second bridge circuits can be fed to an evaluation device which determines a transverse force signal independent of torsional and bending moments.

In a development, the strain-sensitive resistors of the first and/or second bridge circuits are arranged outside, and in the edge region of, a cutout running on the surface of the component, and in a fashion embracing said cutout.

This has the advantage that the signal response of the transverse force sensor can be enhanced in a simple way. Because of the cutout, the mechanical stresses acting on the support element are superimposed on one another, the strain in the main directions (longitudinal, transverse) having unequal absolute values, as a result of which the tapped measuring signal at the bridge circuit can be increased in a simple way.

Load-induced changes in the resistance values can be corrected in a particularly simple way when the component has in its edge region radial indentations, and the cutout has radial regions, in each case one radial indentation and one radial region of a cutout being assigned to a resistor which is arranged on a connecting line of the first radius of the indentation and a second radius of the cutout. If the cutout is of circular design, each resistor is arranged radially with approximately equal angular spacings about the cutout. That is to say, the resistors are located at the same spacing from the middle of the bore.

The signal response of the sensor is easily enhanced by the cutout without complex changes to the shaft geometry. Such a sensor is suitable for mass production, since it can be fabricated favorably in terms of cost and time.

The resistors arranged on the metal component are as advantageously designed as thick-film resistors, the sensitivity of the resistance pastes used to produce the resistors differing with respect to longitudinal and transverse strain. An enhancement of the signal response of the sensor is also achieved thereby.

In a development of the invention, the thick-film resistors are arranged in one plane for measuring torsion and for measuring transverse force. However, it is also possible for the thick-film resistors to be arranged in one or more planes.

It is also advantageously possible to use two bridge circuits for measuring torsion, the resistors of the first bridge circuit being arranged in a position r₁<r₀ and the resistors of the second bridge circuit being arranged in a position r₂>r₀, the positions r₁ and r₂ having the same difference relative to the position r₀ in terms of absolute value.

The invention permits numerous embodiments. One of these is to be explained in more detail with the aid of the figures illustrated in the drawing, in which:

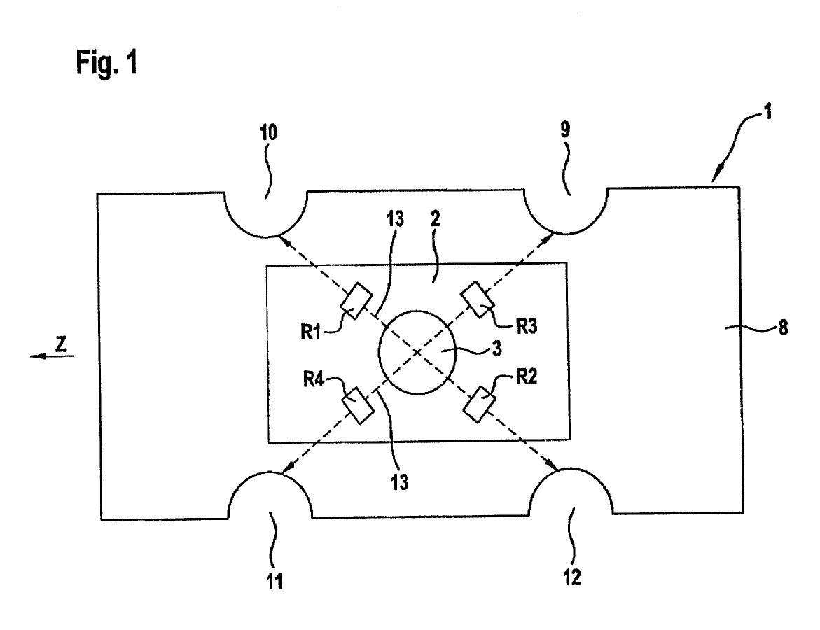

FIG. 1 shows a plan view of a component according to the invention that is to be loaded by torsion,

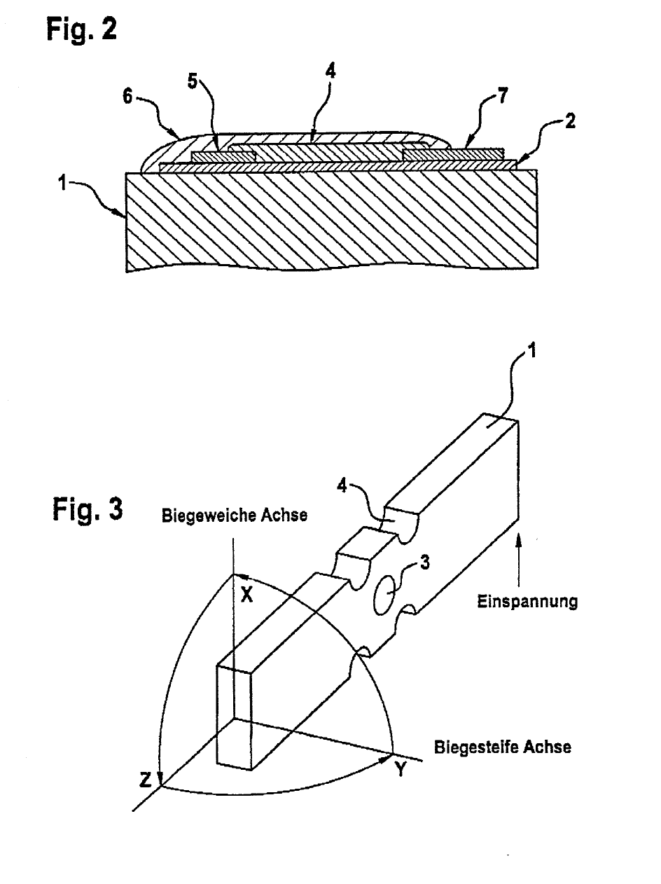

FIG. 2 shows an arrangement of the strain-sensitive resistor on the component according to FIG. 1,

FIG. 3 shows a mechanical loading of the component, and

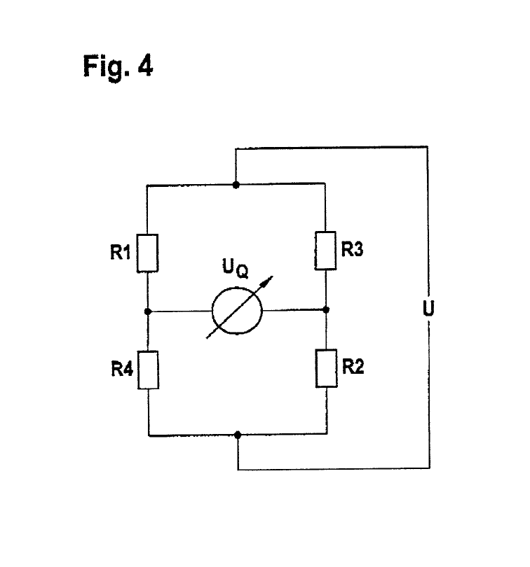

FIG. 4 shows the voltage variation in the bridge circuit.

Identical features are marked with identical reference symbols.

A bending moment sensor is illustrated in FIG. 1. Identically constructed thick-film resistors R1, R2, R3, R4 are arranged on a shaft 1 which is to be loaded by transverse forces, consists of steel or a steel alloy and is cuboid. The resistors R1, R2, R3, R4 are combined to form a bridge circuit in accordance with FIG. 4.

The resistance bridge is arranged in its entire extent on a dielectric 2 which rests directly on the component 1 without intermediate support. A section through a strain-sensitive resistor R1 is illustrated in FIG. 2.

As may be seen from FIG. 2, electric conductor tracks 5 which are formed by a conductor track layer are located on the dielectric 2. An electric resistance layer 9 which forms the resistor R1, R2, R3 or R4 designed as a strain gauge extends between these conductor tracks 5. The closure is formed by a passivation layer 6, which leaves uncovered only that part of at least one conductor track 5 serving as contact surface 7, and serves to make electric contact with the resistor R1.

The strain gauge described is produced immediately on the substrate 1 using thick-film technology.

In order to produce an intimate connection between the dielectric 2 and the component 1, the dielectric 2 is applied to the shaft 1 by means of a non-conducting paste using printing technology. In this case, the paste contains a fritted glass filter, which can be fused at low temperature, as the material of the shaft 1. After application of the paste, a conducting layer is applied, likewise using screen printing technology, and forms the conductor track 5 and the contact surface 7 on which, in turn, the structured resistance layer 4 forming the resistors R1, R2, R3, R4 is arranged. The shaft 1 thus prepared is subjected to heat treatment in a high-temperature process at a temperature of approximately 750 to 900° C. The glass layer is sintered in the process with the surface of the steel of the shaft 1. During this sintering, oxide bridges are formed between the dielectric 2 and the shaft 1 and ensure a permanent connection between the shaft 1 and dielectric 2, resulting in a deeply intimate connection between the two.

As may be seen from FIG. 1, the shaft 1 has a rectangular surface 8, a circular opening 3 which completely penetrates the shaft 1 being formed in the center. The edge of the component 1 has respectively on both sides in its longitudinal extent two semicircular edge cutouts 9, 10 and 11, 12, respectively, the cutouts 10 and 11 as well as 9 and 12 being arranged opposite one another. The radii of the edge cutouts 9, 10, 11, 12 correspond approximately to the radius of the opening 3. The strain gauges R1, R2, R3, R4 are arranged in each case on a line 13 proceeding from the center point of the opening 3, the line 13 constituting the imaginary connection between the radius of an edge cutout 9, 10, 11, 12 and the radius of the opening 3. Because of the opening 3 and the edge cutouts 9, 10, 11, 12, in the case of a torsion load along an imaginary center line Z, two main strains with different absolute values occur on the surface of the shaft 1, said main strains corresponding from the point of view of the respective thick-film resistor R1 to R4 to a longitudinal strain and a transverse strain.

As may be gathered from FIG. 3, torsional and bending forces also occur in the case of loading by transverse forces. In this case, consideration is given to the shaft 1 as a bending beam which is permanently clamped at one end. Proceeding from the fact that the torsion causes a twisting of the shaft in the Z-direction, the X-axis illustrated in FIG. 3 in this case forms a flexurally soft axis, while the axis pointing in the Y-direction is a flexurally stiff axis. The shaft axis Z corresponds in this case simultaneously to the phase of the shaft 1 neutral for the bending load. In accordance with FIG. 1, the resistors R1 and R3 are arranged on one side of the neutral phase, and the resistors R4 and R2 are arranged on the other side of the neutral phase. Since all the resistors R1 to R4 are positioned with the same radial spacing about the cutout 3, they all have the same spacing in terms of absolute value in relation to the neutral phase, but differ from one another in their angular spacing relative to the neutral phase.

In accordance with FIG. 4, in this case the resistors R1, R2, R3, R4 are wired up electrically to form a bridge circuit. It may be seen in this case that there is always one resistor of a bridge arm situated on one side each of the neutral phase. Thus, the resistor R1 of the bridge arm R1, R4 is situated on one side, and the resistor R4 is situated on the other side of the neutral phase. The same holds for the resistors R3 and R2 of the second bridge arm. The resistors behave differently in the case of spatially varying bending load, there being a point relative to the center point of the opening 3 for which the change in resistance is equal in all the resistors R1, R2, R3, R4. This holds for any arbitrary bending load about the flexurally stiff axis.

A bridge signal

$${U}_{Q} = U \cdot \frac{1}{4 R} ( Δ {R}_{1} + Δ {R}_{2} - Δ {R}_{3} - Δ {R}_{4} ) \qquad ( 1 )$$

is yielded in the case of wiring up in accordance with FIG. 4.

The signal U_{Q} to be tapped at the resistance bridge is determined from

U_{Q}=U·Cₛ·Fₓ(z_{c})·(r−r₀),

Cₛ being a factor dependent on the sensor dimensions, the sensor material and the resistance properties, while Fₓ(z_{c}) is the transverse force in the direction of the flexurally soft axis (X-axis, FIG. 1).

Provided for compensating the torsion is a second bridge circuit, which is designed in accordance with FIG. 1 and whose resistors are arranged in the positions r₀. The result for this position is

ΔR₁ΔR₃

Consequently, taking account of FIG. 1, this yields

ΔR₂=ΔR₄,

a bridge signal of

U_{Q}=0.

resulting from the formula 1.

A similar picture results in the case of an arbitrary spatially varying bending load about the flexurally soft axis (X-axis). It holds in this case that:

ΔR₁=ΔR₄ and ΔR₂=ΔR₃

for each radial position R. consequently, U_{Q}=0 is also obtained here for the bridge signal. Any arbitrary bending of the strain gauge can be decomposed into bending components about the flexurally stiff and the flexurally soft axes. The bridge signal is in this case a sum of the signal components of the bending components about the flexurally stiff and flexurally soft axes, respectively. As soon as the resistors are located in the position r₀, there is therefore an exactly bending-compensated sensor for torques about the Z-axis.

A high degree of bending compensation is achieved because of this radial arrangement of the bridge resistors about the cutout. This is advantageous, in particular, when such a strain gauge is used in the application of the electric steering aid, where spatially varying bending moments occur, in particular, on the basis of the concrete state of installation in the vehicle.

A plurality of such bridge circuits can be juxtaposed at will next to one another on such a sensor. Torsional and transverse force measurements can also be performed in this case when the bridge resistors are arranged in one or in a plurality of planes and lead to the same bending-compensated result.

A bending compensation can also be achieved when two bridge circuits are present, the resistors of one bridge being arranged in positions r>r₀, and the resistors of the other bridge being arranged in positions r<r₀, the bending-induced errors respectively having different signs, and the absolute values of the errors being equal.

1. A transverse force sensor comprising a bridge circuit having strain-sensitive resistors, the strain-sensitive resistors being arranged immediately on a component on which bending forces act directly without intermediate support, as a result of which an electric signal corresponding to the strain of the thick-film resistors can be tapped at the bridge circuit, wherein the strain-sensitive resistors (R1, R2, R3, R4) of a first bridge circuit are arranged on the component (1) like a circle, one resistor (R1, R3) each of the first bridge arm being arranged diagonally relative to a resistor (R4, R2) of the second bridge arm, respectively in a position (r) such that the bridge signal depends only on the transverse force.

2. The transverse force sensor as claimed in claim 1, wherein a second bridge circuit is provided whose strain-sensitive resistors (R5, R6, R7, R8) are likewise arranged like a circle, one resistor (R5, R7) each of the first bridge arm being arranged diagonally relative to a resistor (R8, R6) of the second bridge arm, respectively in a position (r₀) in which the changes in resistance of strain-sensitive resistors (R5, R6, R7, R8) of the second bridge circuit assume equal absolute values under the effect of torsion, and the output signals of the first and of the second bridge circuits can be referred to an evaluation device which determines a transverse force signal independent of torsional moment and bending moment.

3. The transverse force sensor as claimed in claim 1 or 2, wherein the strain-sensitive resistors (R1, R2, R3, R4; R5, R6, R7, R8) of the first and/or the second bridge circuits are arranged outside of, and embracing the cutout (3) running on the surface (8) of the component (1).

4. The transverse force sensor as claimed in claim 3, wherein the component (1) has in its edge region radial indentations (9, 10, 11, 12), and the cutout (3) has radial regions, in each case one radial indentation (9, 10, 11, 12) and one radial region of the cutout (3) being assigned to a resistor (R1, R2, R3, R4; R5, R6, R7, R8) which is arranged on a connecting line (13) of the first radius of the indentation (9, 10, 11, 12) and a second radius of the cutout (3).

5. The transverse force sensor as claimed in claim 4, wherein the cutout (3) is of circular design, each resistor (R1, R2, R3, R4; R5, R6, R7, R8) being arranged radially with approximately equal angular spacings about the cutout (3) and perpendicular to the connecting line (13) in its longitudinal extent.

6. The transverse force sensor as claimed in one of the preceding claims, wherein the resistors (R1, R2, R3, R4; R5, R6, R7, R8) are arranged on the plane surface (8) of the component (1) consisting of metal.

7. The transverse force sensor as claimed in claim 6, wherein the resistors (R1, R2, R3, R4; R5, R6, R7, R8) are designed as thick-film resistors, the sensitivity of the resistance pastes used to produce the resistors differing with respect to longitudinal and transverse strain.

8. The transverse force sensor as claimed in claim 6 or 7, wherein the thick-film resistors (R1, R2, R3, R4; R5, R6, R7, R8) are arranged in one plane in order to measure the torsion and/or transverse force.

9. The transverse force sensor as claimed in claim 6 or 7, wherein the thick-film resistors (R1, R2, R3, R4; R5, R6, R7, R8) are arranged in two or more planes for torsion measurement.
